(19) United States
(12) Patent Application Publication
(10) Pub. No.: US 2023/0115113 A1
(43) Pub. Date: Apr. 13, 2023

(54) SYSTEM AND METHOD FOR MACHINE LEARNING ARCHITECTURE FOR MULTI-TASK LEARNING WITH DYNAMIC NEURAL NETWORKS

(71) Applicant: ROYAL BANK OF CANADA, Toronto (CA)

(72) Inventors: Golara JAVADI, Coquitlam (CA); Frederick TUNG, North Vancouver (CA); Gabriel Leivas OLIVEIRA, Vancouver (CA)

(21) Appl. No.: 17/959,900

(22) Filed: Oct. 4, 2022

Related U.S. Application Data
(60) Provisional application No. 63/252,003, filed on Oct. 4, 2021.

(51) Int. Cl. G06N 3/04; G06N 3/08

(52) U.S. Cl. CPC G06N 3/0481; G06N 3/08

(57) ABSTRACT

Disclosed are systems, methods, and devices for computing an action for an automated agent. A neural network configured for deep multi-task learning is provided. Each of a subset of layers of the neural network is connected with a respective gating unit configured for dynamically activating or deactivating the respective layer of the neural network. The method includes: receiving, via a communication interface, input data associated with a task type; selecting, from a plurality of layers of a neural network, a subset of layers based on at least the task type; dynamically activating, based on the input data, at least one layer of the subset of layers; and generating an action signal based on a forward pass of the neural network using the dynamically activated at least one layer of the neural network.

### CROSS-REFERENCE TO RELATED APPLICATION

This application claims the benefit of and priority to U.S. provisional patent application No. 63/252,003 filed on Oct. 4, 2021, the entire content of which is herein incorporated by reference.

### FIELD

The present disclosure generally relates to the field of machine learning, and more specifically, relates to dynamic neural networks suitable for multi-task learning.

### BACKGROUND

Multi-task learning (MTL) focuses on adapting knowledge across multiple related tasks and optimizes a single model to predict all the tasks simultaneously. In contrast to single-task learning, it may improve generalization and parameter efficiency, while reducing the training and inference time by sharing parameters across related tasks. Some implementations of deep multi-task learning approaches use hard or soft parameter sharing to train a single network that can perform multiple predictive tasks. Architectures that use hard parameter sharing are composed of a shared backbone of initial layers, followed by a separate branch for each task. The shared backbone learns generic representations, and the dedicated branches learn task-specific representations. However, hard parameter sharing imposes a restrictive tree structure on the architecture, and is also susceptible to negative transfer, in which some tasks are optimized at the expense of others. Architectures that use soft parameter sharing are composed of multiple task-specific backbones, and parameters are linked across backbones by regularization or fusion techniques. However, scalability is a challenge as the network grows proportionally with the number of tasks.

### SUMMARY

In accordance with an aspect, there is provided a computer-implemented method for dynamically generating an action by an automated agent, the method may include: receiving, via a communication interface, input data associated with a task type; selecting, from a plurality of layers of a neural network, a subset of layers based on at least the task type; dynamically activating, based on the input data, at least one layer of the subset of layers; and generating an action signal based on a forward pass of the neural network using the dynamically activated at least one layer of the neural network.

In some embodiments, each of the subset of layers of the neural network is connected with a respective gating unit configured for dynamically activating or deactivating the respective layer of the subset of layers of the neural network.

In some embodiments, the respective gating unit dynamically activates the respective layer of the subset of layers by: computing, by an relevance estimator, a relevance metric of an intermediate feature input to the respective layer connected to the respective gating unit; and dynamically activating the respective layer connected to the respective gating unit based on the relevance metric.

In some embodiments, the respective gating unit dynamically activates the respective layer of the subset of layers when the relevance metric is at or above a predetermined threshold.

In some embodiments, the respective gating unit dynamically deactivates the respective layer of the subset of layers when the relevance metric is below a predetermined threshold.

In some embodiments, the relevance estimator includes two convolution layers and an activation function.

In some embodiments, the relevance estimator includes an average pooling function between the convolution layers and the activation function.

In some embodiments, the selection of the subset of layers based on at least the task type is determined based on a task-specific policy stored in the memory.

In some embodiments, the dynamically activating the at least one layer of the subset of layers comprises: determining an output using a Rectified Linear Unit (ReLU).

In some embodiments, training of the neural network includes: optimizing a loss function that includes a first term for reducing a probability of an execution of a given layer and a second term that increases knowledge sharing between a plurality of tasks.

In accordance with another aspect, there is provided a computer-implemented system for computing an action for an automated agent, the system include: a communication interface; at least one processor; memory in communication with the at least one processor, the memory storing a neural network for deep multi-task learning; and software code stored in the memory, which when executed at the at least one processor causes the system to: receive, via the communication interface, input data associated with a task type; select, from a plurality of layers of the neural network, a subset of layers based on at least the task type; dynamically activate, based on the input data, at least one layer of the subset of layers; and generate an action signal based on a forward pass of the neural network using the dynamically activated at least one layer of the neural network.

In some embodiments, each of the subset of layers of the neural network is connected with a respective gating unit configured for dynamically activating or deactivating the respective layer of the subset of layers of the neural network.

In some embodiments, the respective gating unit dynamically activates the respective layer of the subset of layers by: computing, by an relevance estimator, a relevance metric of an intermediate feature input to the respective layer connected to the respective gating unit; and dynamically activating the respective layer connected to the respective gating unit based on the relevance metric.

In some embodiments, the respective gating unit dynamically activates the respective layer of the subset of layers when the relevance metric is at or above a predetermined threshold.

In some embodiments, the respective gating unit dynamically deactivates the respective layer of the subset of layers when the relevance metric is below a predetermined threshold.

In some embodiments, the relevance estimator includes two convolution layers and an activation function.

In some embodiments, the selection of the subset of layers based on at least the task type is determined based on a task-specific policy.

In some embodiments, the dynamically activating the at least one layer of the subset of layers comprises: determining an output using a Rectified Linear Unit (ReLU).

In some embodiments, training of the neural network comprises: optimizing a loss function that includes a first term for reducing a probability of an execution of a given layer and a second term that increases knowledge sharing between a plurality of tasks.

In accordance with yet another aspect, a non-transitory computer-readable storage medium is provided, the medium storing instructions which when executed adapt at least one computing device to: receive, via a communication interface, input data associated with a task type; select, from a plurality of layers of a neural network, a subset of layers based on at least the task type; dynamically activate, based on the input data, at least one layer of the subset of layers; and generate an action signal based on a forward pass of the neural network using the dynamically activated at least one layer of the neural network.

In some embodiments, each of the subset of layers of the neural network is connected with a respective gating unit configured for dynamically activating or deactivating the respective layer of the subset of layers of the neural network.

In some embodiments, the respective gating unit dynamically activates the respective layer of the subset of layers by: computing, by an relevance estimator, a relevance metric of an intermediate feature input to the respective layer connected to the respective gating unit; and dynamically activating the respective layer connected to the respective gating unit based on the relevance metric.

In some embodiments, the respective gating unit dynamically activates the respective layer of the subset of layers when the relevance metric is at or above a predetermined threshold.

In some embodiments, the respective gating unit dynamically deactivates the respective layer of the subset of layers when the relevance metric is below a predetermined threshold.

In some embodiments, the relevance estimator includes two convolution layers and an activation function.

In some embodiments, the selection of the subset of layers based on at least the task type is determined based on a task-specific policy.

In some embodiments, the dynamically activating the at least one layer of the subset of layers comprises: determining an output using a Rectified Linear Unit (ReLU).

In some embodiments, training of the neural network comprises: optimizing a loss function that includes a first term for reducing a probability of an execution of a given layer and a second term that increases knowledge sharing between a plurality of tasks.

### BRIEF DESCRIPTION OF THE FIGURES

In the Figures,

FIG. 1A is a block schematic diagram of an example system for a dynamic multi-task neural network, according to some embodiments;

FIG. 1B is a schematic diagram of an automated agent, in accordance with an embodiment;

FIG. 1C is a schematic diagram of an example neural network maintained at the computer-implemented system of FIG. 1A, in accordance with an embodiment;

FIG. 2 is an example screen from a lunar lander game, in accordance with an embodiment;

FIG. 3 is an example schematic diagram of a multi-task neural network being used to generate an action signal based on an input with a task type, according to some embodiments;

FIG. 4 is an example schematic diagram showing a fusion of task-specific policy and instance-specific gating outputs, according to some embodiments;

FIG. 5 is flowchart of an example process for computing an action for an automated agent, according to some embodiments;

FIG. 6 is a schematic diagram of an example computing device suitable for implementing the system of FIG. 1A, according to some embodiments;

FIG. 7 is a table showing experimental results on the NYU v2 dataset for the tasks of semantic segmentation and surface normal prediction, according to some embodiments;

FIG. 8 is a table showing comparison of computational cost of two different neural network models, including an example embodiment trained on the NYU v2 dataset, according to some embodiments;

FIG. 9 is a table showing experimental results on the CityScapes 2-Task dataset (semantic segmentation and depth prediction), according to some embodiments;

FIG. 10 is a table showing AUC results for the MIMIC-III dataset, according to some embodiments;

FIG. 11 is a table showing comparison of computational cost of two different neural network models, including an example embodiment trained on the CityScapes dataset, according to some embodiments; and

FIG. 12 is a table showing ablation studies to evaluate the impact of the task-specific policy and instance-specific gating on overall multi-task learning performance on the MIMIC-III dataset.

These drawings depict exemplary embodiments for illustrative purposes, and variations, alternative configurations, alternative components and modifications may be made to these exemplary embodiments.

### DETAILED DESCRIPTION

Multi-task learning focuses on adapting knowledge across multiple related tasks and optimizes a single model to perform all tasks simultaneously. Multi-task networks rely on effective parameter sharing (e.g., weight sharing) to achieve robust generalization across tasks. Traditionally, multi-task networks have employed hard or soft parameter sharing strategies. Networks that use hard parameter sharing are composed of a shared backbone of initial layers, followed by a separate branch for each task. The shared backbone learns generic representations, and the dedicated branches learn task-specific representations. Architectures that use soft parameter sharing are composed of multiple task-specific backbones, and parameters are linked across backbones by regularization or fusion techniques. However, scalability is a challenge as the network grows proportionally with the number of tasks.

In either case of parameter sharing, in these traditional methods, the path through the network at inference time is the same for all tasks and inputs.

Multi-task networks rely on effective parameter sharing to achieve robust generalization across tasks. In this disclosure, a novel parameter sharing technology for multi-task neural network learning is described, that conditions parameter sharing on both the task and the intermediate feature representations at inference time. In contrast to traditional parameter sharing approaches, which fix or learn a deterministic sharing pattern during training and apply the same pattern to all examples during inference, the disclosed system is configured to dynamically decide which parts of the network to activate based on both the task and the input instance. The disclosed technology system learns a hierarchical gating policy implemented by a task-specific policy for coarse layer selection and one or more gating units (or simply referred to as “gates”) for individual input instances, which work together to determine the execution path at inference time.

The disclosed system implements a multi-task network to dynamically decide which parts or blocks of the neural network to activate based on both the task and the input instance. Used herein, the term “block” may mean one or more layers of a neural network. Each layer may include a set of parameters (e.g., weights and biases) used to process input data in a forward pass.

The systems and methods described herein are novel approaches to deep multi-task learning that learns from the training data a hierarchical gating policy consisting of a task-specific policy for coarse layer selection and gating units for individual input instances, which work together to determine the execution path at inference time.

In the disclosed system and method, dynamic neural networks are employed for computational efficiency (e.g. to reduce the inference time footprint with respect to parameters), and to leverage task and instance conditioning to boost the weight sharing flexibility of a multi-task neural network, with the effect of better generalization across the multiple tasks.

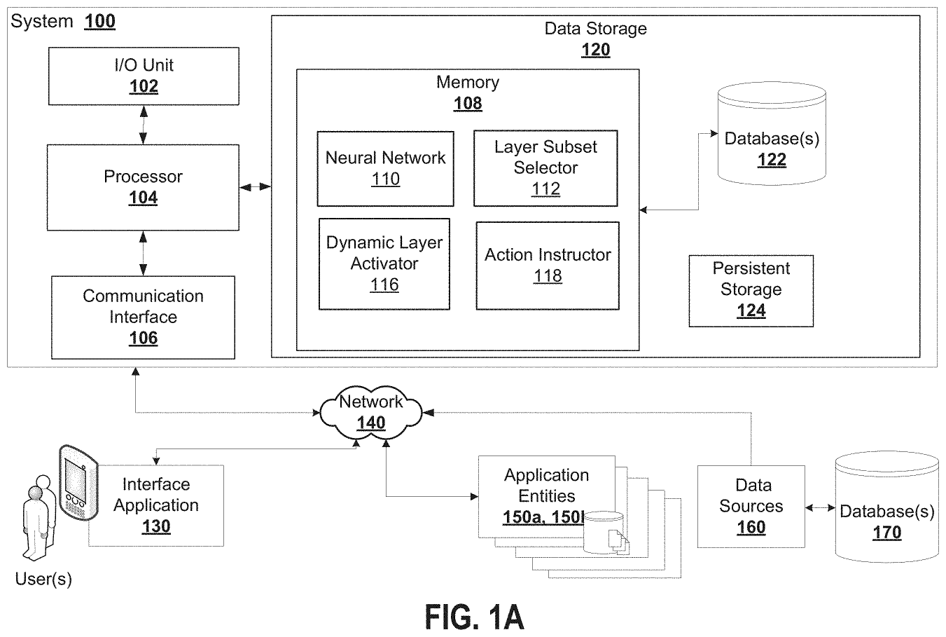

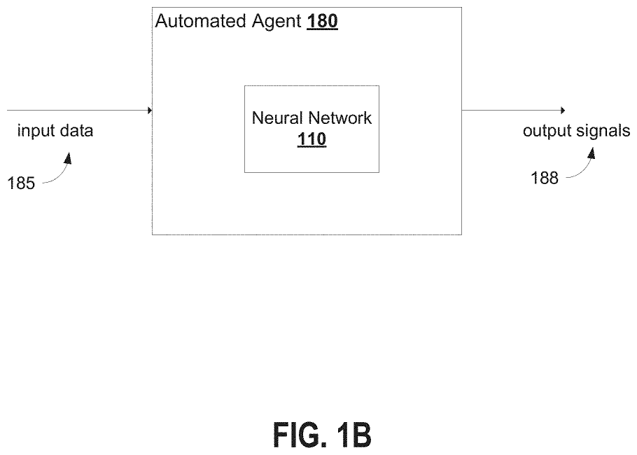

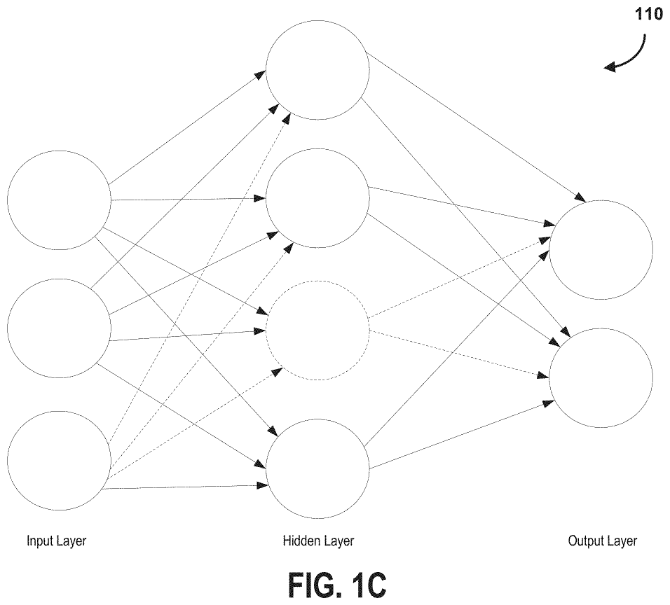

FIG. 1A is a high-level schematic diagram of a computer-implemented system 100 for providing an automated agent having a neural network 110, in accordance with an embodiment. The automated agent is instantiated and trained by system 100 in manners disclosed herein to generate action signals or resource requests.

As detailed herein, in some embodiments, system 100 includes features adapting it to perform certain specialized purposes. For example, in various embodiments, system 100 includes features adapting it for automatic control of a heating, ventilation, and air conditioning (HVAC) system, a traffic control system, a vehicle control system, or the like.

Referring now to the embodiment depicted in FIG. 1A, system 100 has data storage 120 storing a neural network 110. The neural network 110 is used by system 100 to instantiate one or more automated agents 180 (FIG. 1B).

A processor 104 is configured to execute machine-executable instructions to train a neural network 110 based on a loss function.

Throughout this disclosure, it is to be understood that the terms “average” and “mean” refer to an arithmetic mean, which can be obtained by dividing a sum of a collection of numbers by the total count of numbers in the collection.

The system 100 can connect to an interface application 130 installed on user device to receive input data. Application entities 150a, 150b can interact with the system 100 to receive output data and provide input data. The application entities 150a, 150b can have at least one computing device. The system 100 can train one or more multi-task learning neural networks 110. The trained multi-task learning networks 110 can be used by system 100 or can be for transmission to application entities 150a, 150b, in some embodiments. The system 100 can process action signals or resource requests using the multi-task learning network 110 in response to commands from application entities 150a, 150b, in some embodiments.

The system 100 can connect to different data sources 160 and databases 170 to receive input data and receive output data for storage. The input data can include input data associated with a task, or a task type. For example, the input data from data sources 160 may include one or more images, the task may be to recognize an image having a cat, and the task type may be animal-recognition.

Network 140 (or multiple networks) is capable of carrying data and can involve wired connections, wireless connections, or a combination thereof. Network 140 may involve different network communication technologies, standards and protocols, for example.

The system 100 can include an I/O unit 102, a processor 104, communication interface 106, and data storage 120. The I/O unit 102 can enable the system 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), neural network 110, layer subset selector 112, dynamic layer activator 116, action instructor 118 and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data (via a data collection unit) 185 and generates output signal 188 according to its neural learning network 110, and the output may be processed for transmission to application entities 150a, 150b.

FIG. 1C is a schematic diagram of an example neural network 110, in accordance with an embodiment. The example neural network 110 can include an input layer, one or more hidden layers, and an output layer. The neural network 110 processes input data using parameters, such as weights and/or biases, in the layers based on multi-task learning, for example. One or more layers of the neural network 100 may be referred to as a block of a neural network 110; a block of neural network 110 may receive, from a previous block, intermediate feature representation as input and generate an output based on the intermediate feature representation. The intermediate feature representation may be referred to as input data to a layer of the block, or input data to the block.

Referring back to FIG. 1A, the interface unit 130 interacts with the system 100 to exchange data (including control commands) and generates visual elements for display at user device. The visual elements can represent input data and task to neural network 110 and output generated by neural network 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The system 100 can be operable to register and authenticate users (using a login, unique identifier, and password for example) prior to providing access to applications, a local network, network resources, other networks and network security devices. The platform 100 may serve multiple users which may operate application entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

The processor 104 is configured with machine executable instructions to instantiate and train an automated agent 180 that maintains a neural network 110. Input data may include image data, video data, time series data, or other types of data. Output signals may include signals for communicating resource task requests, e.g., a request to perform a certain user action.

In some embodiments, neural network 110 is configured for deep multi-task learning and trained to perform tasks or generate predictions corresponding to a variety of task types, which may be referred to as “actions” herein. Neural network 110 can include one or more layers and at least one layer has a corresponding gate (or gating unit) associated with it. A gate can control activation of the corresponding layer based on the input data in a forward pass of neural network 110.

In some embodiments, layer subset selector 112 is configured to select a subset of the layers of neural network 110 based on, for example, the task type of a given task associated with the input data. The subset of layers can include layers with parameters optimized for the task type, and layers with parameters optimized for general representations (i.e., shared between tasks). In this way, the layer subset selector 112 performs a coarse layer selection based on a task type associated with input data. A task type can be, for example, facial recognition based on input data (e.g., video frames), or depth determination based on input data (e.g., images captured on a camera). The layer subset selector 112 can select a respective subset of layers of neural network 110 based on if it is a task type 1 or task type 2. Each task type may be associated with a task policy and a task specific structure stored in memory 108 or database 122.

In some embodiments, dynamic layer activator 116 can dynamically activate particular layers based on the input data. In some embodiments, dynamic layer activator 116 can estimate the relevance of a specific layer in view of the input data sent to the specific layer, by computing a relevance metric of the specific layer. Dynamic layer activator 116 can selectively activate or deactivate (e.g., skip) the specific layer depending on the value of relevance metric, e.g., in comparison to a pre-defined threshold. This selective activation can be performed with the a gating unit associated with the specific layer. In some embodiments, for example when processing simple inputs, the system may skip intermediate layers because the earlier layers can adequately describe the input. For other, more complex input, the intermediate layers may need to be activated so that the system can adequately process the input. Therefore, dynamic activation of one or more layers may increase processing efficiency of a neural network 110 at inference time.

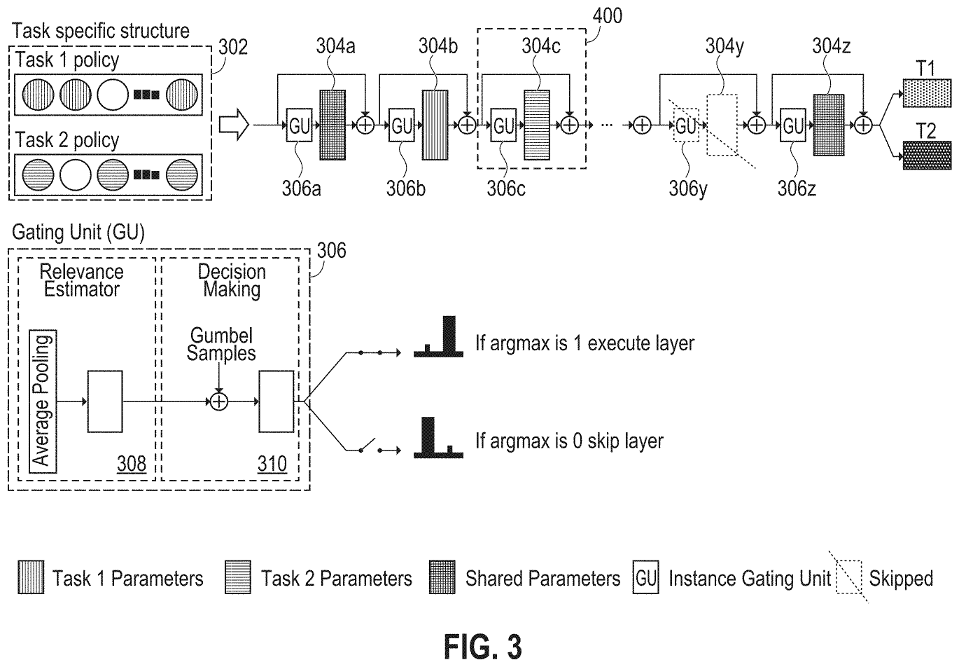

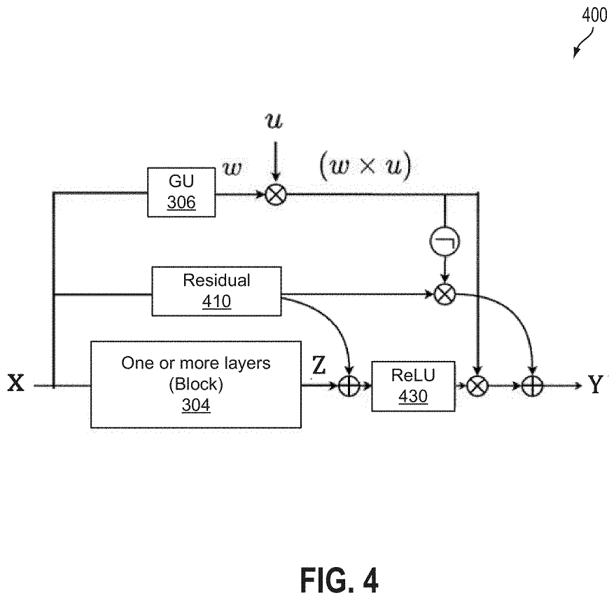

In a forward pass, neural network 110 can generate an output under control of the layer subset selector 112 and dynamic layer activator 116, as further described in connection with FIGS. 3 and 4 below.

Action instructor 118, which may be part of automated agent 180, receives the output (e.g., an estimation or prediction) by neural network 110 and generates an action signal. In some embodiments, the action signal may be generated based on pre-set rule applied to an output of neural network 110. In some embodiments, the action signal may be directly outputted by neural network 110.

Electronic database 122 is configured to store various data utilized by the system 100 including, for example, training data, model parameters, hyperparameters, and the like. Electronic database 122 may implement a conventional relational or object-oriented database, such as Microsoft SQL Server, Oracle, DB2, Sybase, Pervasive, MongoDB, NoSQL, or the like.

In accordance with an aspect, there is provided a computer-implemented system 100 for computing an action for an automated agent. The system includes at least one processor; a memory 110 in communication with said at least one processor; and a neural network 110 configured for deep multi-task learning. The neural network 110 may include a plurality of layers; and for at least one of the layers, a gate corresponding to that layer for controlling activation of that layer based on at least input data. The system may also include software code stored in the memory. When executed by the at least one processor, the software code may cause the system to receive the input data reflective of a particular task of a given task type; in a forward pass of the neural network, select a subset of layers of the neural network based on at least the given task type, using layer subset selector 112, and dynamically activate one or more of the layers of the subset of layers using the gate corresponding to that layer and based on at least the received input data, using dynamic layer activator 116; and request the automated agent perform the action, using action instructor 118.

In accordance with a further aspect, the dynamically activation of one or more of the layers using dynamic layer activator 116 may include estimating a relevance metric of the input to a given layer, and selectively activating the given layer based on the relevance metric.

In accordance with a further aspect, the software code, when executed by the at least one processor, may further cause the system to output the relevance metric to facilitate decision-making transparency. For example, inputs which are simple to process may not be relevant to many layers and may have lower relevance metrics, while complex inputs may require analysis by many layers and therefore have higher relevance metrics.

In accordance with a further aspect, the action may include a potential response to a user query. In an embodiment, the system 100 is configured to provide an automated agent 180 that responds to user queries. The example system 100 may parse the query to determine the substance of the user query using natural language processing, determine the substantive information to respond to the query, and formulate the response to naturally reply to the user's query. In some embodiments, the users may be banking customers.

In accordance with a further aspect, the action may include a date or amount of a future payment or expense. In an embodiment, the system 100 is configured to predict and post future expenses or credits for a user. In this example system 100, the prediction model for different types of expenses or credits may share some parameters, but not all. Further, the dynamic layer activation for similar types of expenses or credits may permit the system 100 to potentially process the inputs more efficiently. In some embodiments, the users may be banking customers.

In accordance with a further aspect, the software code, when executed by the at least one processor, may further cause the system to train neural network 110.

In accordance with a further aspect, the training may include optimizing a loss function that includes a first term for reducing the probability of the execution of a given layer and a second term for increasing knowledge sharing between tasks.

In accordance with a further aspect, the training may include receiving a supervised training data set.

### Example Practical Applications

As shown in FIG. 1B, automated agent 180 receives input data 185 (e.g., from one or more data sources 160 or via a data collection unit) and generates output signal 188 according to a multi-task neural network 110. In some embodiments, the output signal 188 can be transmitted to another system, such as a control system, for executing one or more commands represented by the output signal 188.

In some embodiments, once the neural network 110 has been trained, it generates output signal 188 reflective of its decisions to take particular actions in response to input data 185. Input data 185 can include, for example, a set of data obtained from one or more data sources 160, which may be stored in databases 170 in real time or near real time.

As a practical example, an HVAC control system which may be configured to set and control heating, ventilation, and air conditioning (HVAC) units for a building, in order to efficiently manage the power consumption of HVAC units, the control system may receive time-series sensor data representative of temperature data in a historical period. In this example, components of the HVAC system including various elements of heating, cooling, fans, or the like may be considered resources subject of a resource task request 188. The control system may be implemented to use an automated agent 180 and a trained multi-task neural network 110 to generate an output signal 188, which may be a resource request command signal 188 indicative of a set value or set point representing a most optimal room temperature based on the sensor data, which may be part of input data 185, representative of the temperature data in present and in a historical period (e.g., the past 72 hours or the past week). The neural network 110 may be trained to perform multiple tasks based on one or more sets of time-series sensor data: for example, a first subset of layers or blocks of the neural network 100 may be dynamically activated to receive the time-series sensor data to perform a first task, e.g., generating a set value or set point in order to achieve a most optimal room temperature in X minutes when human occupants are present; for another example, a second subset of layers or blocks of the neural network 100 may be dynamically activated to receive the same time-series sensor data or a second set of time-series data and perform a second task, e.g., generating a set value or set point in order to achieve a room temperature in X minutes in order to conserve energy when human occupants are absent.

The input data 185 may include a time series data that is gathered from sensors 160 placed at various points of the building. The measurements from the sensors 160, which form the time series data, may be discrete in nature. For example, the time series data may include a first data value 21.5 degrees representing the detected room temperature in Celsius at time t₁, a second data value 23.3 degrees representing the detected room temperature in Celsius at time t₂, a third data value 23.6 degrees representing the detected room temperature in Celsius at time t₃, and so on.

In some examples, one or more automated agents 180 may be implemented, each agent 180 for controlling the room temperature for a separate room or space within the building which the HVAC control system is monitoring.

As another example, in some embodiments, a traffic control system which may be configured to set and control traffic flow at an intersection. The traffic control system may receive sensor data representative of detected traffic flows at various points of time in a historical period. The traffic control system may use an automated agent 180 and trained reinforcement learning network 110 to control a traffic light based on input data representative of the traffic flow data in real time, and/or traffic data in the historical period (e.g., the past 4 or 24 hours). In this example, components of the traffic control system including various signaling elements such as lights, speakers, buzzers, or the like may be considered resources subject of a resource task request 188.

The input data 185 may include sensor data gathered from one or more data sources 160 (e.g. sensors 160) placed at one or more points close to the traffic intersection. For example, the time series data 112 may include a first data value 3 vehicles representing the detected number of cars at time t₁, a second data value 1 vehicles representing the detected number of cars at time t₂, a third data value 5 vehicles representing the detected number of cars at time t₃, and so on.

The neural network 110 may be trained to perform different tasks based on different input data. For example, given a desired traffic flow value at tₙ, the automated agent 180, based on neural network 110, may generate an output signal 188 to lengthen a green traffic light signal at the intersection, in order to ensure the intersection is least likely to be congested during one or more points in time. For another example, given a command to let detected pedestrians cross the road, the automated agent 180, based on neural network 110, may generate an output signal 188 to immediately display a red light signal at the intersection, in order to ensure that the pedestrians can cross the road safely.

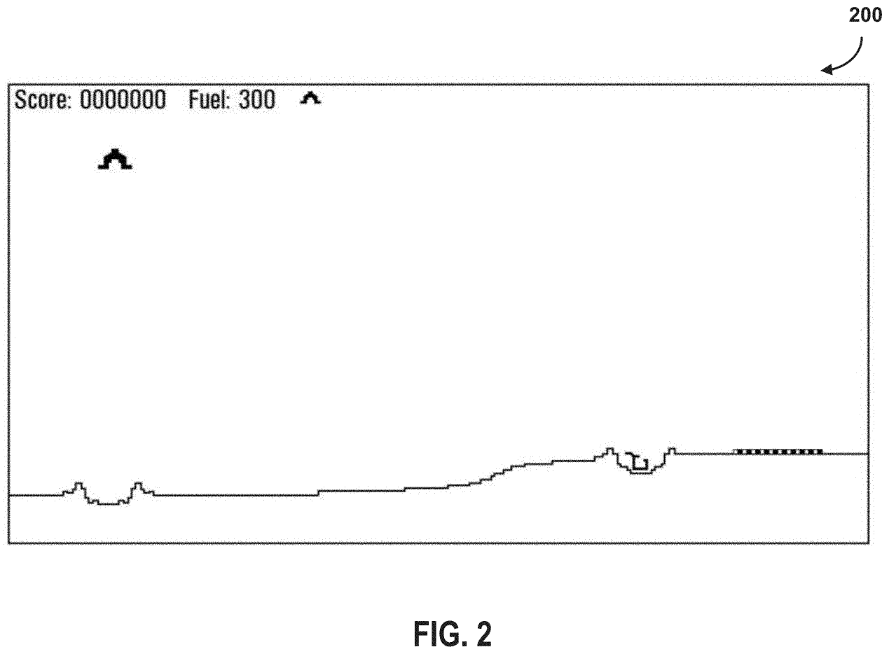

In some embodiments, as another example, a neural network 110 in system 100 may be trained to play a video game, and more specifically, a lunar lander game 200, as shown in FIG. 2. In this game, the goal is to control the lander's two thrusters so that it quickly, but gently, settles on a target landing pad. In this example, input data 185 provided to an automated agent 180 may include, for example, X-position on the screen, Y-position on the screen, altitude (distance between the lander and the ground below it), vertical velocity, horizontal velocity, angle of the lander, whether lander is touching the ground (Boolean variable), etc.

In this example, components of the lunar lander such as its thrusters may be considered resources subject of a resource task request 188 computed by a multi-task neural network 110. A first task given to the trained neural network 110 may be to determine a most optimal landing speed to preserve the most amount of fuel. A second task given to the trained neural network 110 may be to determine a landing position in order to safely land the robot.

FIG. 3 is an example schematic diagram of a multi-task neural network being used to generate an action signal based on an input with a task type.

In a forward pass of a set of input data, which may be associated with a task type, the task type may correspond to a specific task policy 302. The neural network layers or blocks 304a-304z in FIG. 3 each is associated with a hierarchical gating policy, which includes a task-specific policy 302 for a coarse layer selection, and gating units 306a-306z for individual input instances, which work together to determine the execution path at inference time. This structure provides improved computational efficiency (e.g. reducing the inference time footprint with respect to parameters), achieves machine learning model compression, and also leverages task and instance conditioning to boost the weight sharing flexibility of a multi-task network, with the end goal of enabling better generalization across the multiple tasks.

This configuration of neural network 110 implements a novel and fully differentiable dynamic technique for multi-task learning in which parameter sharing is conditioned on both the task and the intermediate feature representations of the input instance. For example, parameter sharing enables a large number of candidate architectures to be simultaneously trained within a single supernet. Each candidate architecture corresponds to a single execution path in the supernet. In multi-task learning, parameter sharing enables paths for multiple tasks to be simultaneously trained. The systems disclosed herein support differentiated treatment of tasks, such as balancing different tasks based on difficulty or importance in the operational context.

In an example neural network 110 implemented as shown in FIG. 3, a layer or block 304a, 304b, 304c, 304y, 304z can be executed exclusively by one task, shared by multiple tasks, or skipped entirely.

In some exemplary embodiments, the task policies 302 can be used to determine a subset of layers that will be used for a particular task or task type. The subset selected include layers relevant to that task with shared parameters. Blocks 304 (inclusive of blocks 304a-304z) may include one or more layers.

By way of example of subset selection, for task 1, the system 100 may use the task 1 policies to select a subset of layers that will include task 1 block 304b because that includes parameters relevant only to task 1 and shared parameter blocks 304a and 304z because those both include parameters shared between the tasks, but not block 304c because block 304c includes parameters relevant only to task 2 (and therefore not relevant to task 1).

Each block (and/or layer) may include a gating unit 306 (inclusive of gating units 306a-306z). In one example embodiment, gating unit 306 can include relevance estimator 308 and decision maker 310. Relevance estimator 308 can estimate a relevance metric which can provide an unnormalized score for the actions. In some embodiments, relevance estimator 308 may downsample the feature map using an average pooling. For example, the system may 100 calculate an average value for patches of a feature map to create a downsampled (or pooled) feature map. In some embodiments, the relevance estimator 308 includes two convolution layers followed by an activation function.

Decision maker 310 is configured to make a decision as to whether to activate or skip a specific layer based on the output from the relevance estimator 308. For example, in some embodiments, decision maker 308 will make the decision to activate a layer based on a relevance metric generate by the the relevance estimator 308.

Gating unit 306 can be trained using Gumbel-Softmax sampling.

Other embodiments may use different gating mechanisms such as reinforcement learning within gating units 306.

Returning to the example above, when the system 100 is processing input for task 1, then the input will be processed by block 304a, 304b, and 304z. Prior to being processed by these blocks, the input will be processed by the gating units immediately preceding these blocks. For example, before being processed by block 304a, the input data sent to block 304a will be checked by gating unit 306a. If gating unit 306a determines that the block is relevant to the input, then it will activate block 304a. If gating unit 306a determines that block 304a is not sufficiently relevant to the input, then it will not activate block 304a. Corresponding gating processes will occur at gating units 306b, 306y, 306z for blocks 304b, 304y and 304z respectively. Gating unit 306c will not check the input for task 1 because block 304c was not selected by the policies of task 1, based on the task policy 302 associated with the input data.

Blocks may not be relevant to input if the neural network 110 is able to adequately describe the input using previous blocks (e.g., if determining whether an image is a cat or a dog, the image may have several features that the neural network 110 may use to efficiently describe the image as a dog with beginning layers such that subsequent layers will not strongly influence the system's determination). Blocks that are not relevant can be skipped which may preserve processing power.

Referring now to FIG. 4, which shows an example embodiment 400 of a fusion of a task-specific policy and an instance-specific gating output implemented to activate or deactivate a layer or block 304. Given the block input X, the gating unit GU 306 produces the instance-specific gating output w ∈ {0,1} and the block 304 produces Z. The task-specific policy output is denoted by u ∈ {0,1}. The resulting gated output Y is is a function of X, Z, u, and w.

Given block input X, the task-specific policy output u ∈ {0,1} can be refined or modified by the instance gating output w ∈ {0,1} to produce block output Y as follows:

$$Y = \{ \begin{matrix}residual ( X ) if u = 0 \\ residual ( X ) if u = 1 and w = 0 \\ ReLU ( residual ( X ) + Z ) if u = 1 and w = 1\end{matrix}$$

where Z is the output of the convolutional block.

In short, when the task-specific policy output u and instance-specific gating output w both indicate that the block 304 should be activated (e.g., u=1 and w=1), the resulting block output is ReLU(residual(X)+Z), based on a Residual component 410 and a ReLU component 430. When either the task-specific policy or instance-specific gating does not activate the block (u=0 or w=0), the resulting output is residual(X), skipping that block 304.

A layer or block 304 is selected when the values of the task-specific policy output u and instance-specific gating output w both indicate that the layer or block 304 is relevant to the task and the input to that layer or block 304. In some embodiments, the specific input to block 304, X, may be intermediate feature representation generated by a previous block that was activated in the forward pass.

Residual (X) can perform linear projection of X onto Y, when the size of input is changing.

Described herein include, among other things, a novel and differentiable fully dynamic method for multi-task learning where the network structure can be adapted based on both a task type of the input data and individual instances from the input data. Embodiments of the methods described herein have had their effectiveness extensively verified. Experimental results on three public datasets (NYUv2, Cityscapes and MIMIC-III), demonstrate the potential of these methods.

Methods and systems described herein provide a flexible parameter sharing method for multi-task learning in which parameter sharing is conditioned on both the task and the intermediate feature representations of the input instance. The neural network in system 100, during training, learns from the training data a hierarchical gating policy consisting of a task-specific policy for coarse layer selection and gating units for individual input instances, which work together to determine the execution path at inference time.

First, the task-specific policy of the methods described herein is explained and a static gating policy for each task is established. The task-specific policy is then expanded on with instance-specific gating units, which learn a dynamic gating that further modifies the task-specific policy decision based on the instance.

### Hierarchical Gating Policy

In some embodiments, a task-specific policy establishes a static layer execution policy for each task. The task-specific policy is a discrete vector that determines which layers to execute or skip for each task (see e.g. FIG. 3). Learning a discrete policy in a standard end-to-end differentiable training framework can be challenging. The task-specific policy can be optimized through the use of Gumbel-Softmax sampling. The network weights and the parameter sharing policy may be trained jointly. To designate a sharing pattern, a task-specific policy from the learned distribution is sampled to specify which blocks are selected in different tasks.

In addition, the instance-specific gating units 306 learn to dynamically adjust the selection decisions of the task-specific policy based on the intermediate feature representations at inference time. An instance gating unit may provide two functions: estimating relevance of each layer to the input of the same layer, and making the decision to keep or skip the layer based on the estimated relevance. The relevance estimator can include, for example, two convolution layers followed by an activation function. An average pooling may be used as well to sample down the features, in some embodiments. The computed output score of the relevance estimator can be used to further make a decision on executing the layer of the neural network 110 for each individual input sent to the layer. Similar to task-specific policy learning, the discrete controller can be trained with the use of Gumbel-Softmax sampling.

Without adding significant number of parameters, the network weights and the feature sharing policy can be trained jointly. To designate a sharing pattern, a task-specific policy from the learned distribution can be sampled to specify which blocks are selected in different tasks. Once the task-specific policy is defined, the instance gating (which may also be referred to as instance-specific gating) may refine the structure based on individual inputs.

Instance-specific gating can learn a policy that further adjusts the selection decisions of the task-specific policy based on the characteristics of the input (instance). This may include, for example, selecting a subset of layers or blocks based on the input. Methods described herein can learn a joint task and instance adaptive layer gating mechanism and illustrates their potential in dynamic multi-task learning.

### Gumbel-Softmax Sampling

Given a set of T={ [symbol] ₁, [symbol] ₂, . . . , [symbol] _{K}} tasks over a dataset. Gumbel-Softmax sampling can be used for learning both task-specific and instance-specific discrete value policies. With this method a decision can be generated from the Equation 1, instead of sampling from the distribution of a binary random variable to find the optimized policy for each block l and specific task [symbol] ₖ, the decision can be generated from:

$${u}_{l , k} = {argmax}_{j ∈ \{ 0 , 1 \}} ( log {π}_{l , k} ( j ) + {G}_{l , k} ( j ) ) , \qquad ( 1 )$$

where π_{l,k}=[1−a_{l,k}, a_{l,k}] is its distribution vector with a_{l,k} representing the probability of lₜₕ layer being executed for task [symbol] ₖ. G_{l,k}=−log(−log U_{l,k}) are Gumbel random variables with U_{l,k} sampled from a uniform distribution. k (lowercase) refers to the kₜₕ task, and K (uppercase) is the total number of tasks.

With reparameterization trick ([10]), the non-differentiable argmax operator in Eq. 1 can be relaxed as:

$${u}_{l , k} ( j ) = \frac{exp ( ( log {π}_{l , k} ( j ) + {G}_{l , k} ( j ) ) / τ )}{{\sum }_{j ∈ \{ 0 , 1 \}} exp ( ( log {π}_{l , k} ( j ) + {G}_{l , k} ( j ) ) / τ )} , \qquad ( 2 )$$

where τ is the softmax temperature.

When τ→0, the softmax function gets closer to the argmax function and a discrete sampler may be obtained. When τ→∞ it becomes a uniform distribution. For task-specific policy during training, the relaxed version given by Eq. 2 can be used. For example, the initial value can be set to τ=5 and gradually decreased to 0.

After training, the learned distribution can be sampled to obtain a discrete task-specific policy. For learning the instance-specific policy, a discrete sample from Eq. 1 can be obtained during the forward pass and the gradient of relaxed version given by Eq. 2 can be computed in the backward pass.

### Loss Functions

Some embodiments of methods described herein may preferentially achieve high performance across multiple tasks by employing a flexible and efficient parameter sharing strategy. For effective parameter sharing, sharing the blocks of neural network 110 among different tasks is implemented, and splitting parameters with no knowledge sharing can be prevented.

In some embodiments, sparsity regularization and sharing loss can be used ( [symbol] _{sparsity} and [symbol] _{sharing}, respectively) to minimize the log-likelihood of the probability of a block being executed and maximise the knowledge sharing simultaneously:

$${ℒ}_{s p a r s i t y} = {\sum }_{l \leq L , k \leq K} log {α}_{l , k} , \qquad ( 3 )$$

$${ℒ}_{sharing} = {\sum }_{{k}_{1} , {k}_{2} \leq K} {\sum }_{l \leq L} \frac{L - l}{L} \vert {α}_{l , {k}_{1}} - {α}_{l , {k}_{2}} \vert , \qquad ( 4 )$$

where L is the total number of layers, a_{l,k}_{ₙ} representing the probability of lₜₕ layer being executed for task [symbol] ₖ_{ₙ}, k (lowercase) refers to the kₜₕ task (e.g., [symbol] ₖ_{₁} or [symbol] ₖ_{₂}), and K (uppercase) is the total number of tasks. For learning the instance gating, a loss term that can encourage each layer to be executed at a certain target rate t can be added.

The execution rates over each mini-batch can be estimated and deviation from given target rate can be penalized. The instance loss can be calculated as:

[symbol]

_{instance}=Σ_{l≤L}(βₗ−t)², (5)

where βₗ is the fraction of instances within a mini-batch for which the lₜₕ layer is executed.

Including the task-specific losses, the final training loss of the neural network 110 described herein can be:

[symbol]

ₜₒₜₐₗ=Σₖλₖ [symbol] ₖ+λ_{sparsity} [symbol] _{sparsity}+λ_{sharing} [symbol] _{sharing}+λ_{instance} [symbol] _{instance}, (6)

where [symbol] ₖ is the task-specific loss, weights λₖ are used for task balancing, and λ_{sparsity}, λ_{sharing}, λ_{instance} are the balance parameters for sparsity, sharing and instance losses, respectively. k (lowercase) refers to the kₜₕ task.

Shown below is an example training algorithm of neural network 110, in accordance with an example embodiment. During the training of neural network 110, the weights of the neural network 110 are updated and stored in memory.

Algorithm 1: DynaShare training algorithm

| | |
|---|---|
| 1: | t ← 1 [symbol] target rate equal to 1 means all the layers are |
| | executed for all the instances (Eq. 5) |
| 2: | for warm-up epochs do [symbol] Warm-up stage: hard parameter |
| | sharing |
| 3: | [symbol] _{Total} = Σₖ λₖ [symbol] ₖ |
| 4: | optimise network weights |
| 5: | end for |
| 6: | while maximum epochs not reached do [symbol] Optimise network |
| | and task policy distribution alternatively |
| 7: | for e₁ epochs do |
| 8: | [symbol] _{Total} = Σₖ λₖ [symbol] ₖ |
| 9: | optimise network weights |
| 10: | end for |
| 11: | for e₂ epochs do |
| 12: | [symbol] _{Total} = Σₖ λₖ [symbol] ₖ + λ_{sparsity} [symbol] _{sparsity} + |
| | λ_{sharing} [symbol] _{sharing} |
| 13: | optimise task policy distribution |
| 14: | end for |
| 15: | end while |
| 16: | return task policy distribution and network weights |

In some embodiments, as shown in the Training Algorithm 1 above, for the first few epochs, hard parameter sharing may be implemented by sharing all blocks of the neural network 110 across tasks. In some embodiments, the task-specific training strategy disclosed in [25] may be used. This sets the network at a good starting point for policy learning. Curriculum learning [3] may be used to encourage a better convergence. The network and task-specific policy distribution parameters are optimized alternatively as shown in Training Algorithm 1. After learning the task-specific policy distribution, the distribution is sampled and network structure is fixed based on task policy. Then, the neural network 110 can be re-trained to learn the instance-specific gating using the full training set, as shown in Algorithm 2 below.

Algorithm 2: DynaShare re-training algorithm

| | |
|---|---|
| 1: | t ← desired target rate [symbol] (Eq. 5) |
| 2: | task network structure ← sample of task policy |
| 3: | while maximum epochs not reached do |
| 4: | [symbol] _{Total} = Σₖ λₖ [symbol] ₖ + λ_{instance} [symbol] _{instance} |
| 5: | optimise task network structure with target rate |
| 6: | end while |
| 7: | return network weights |

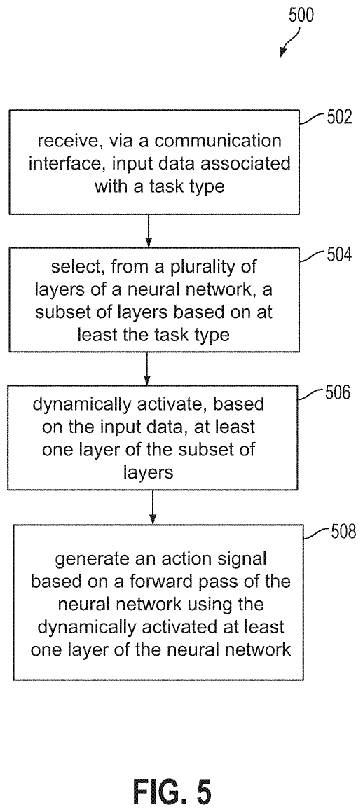

FIG. 5 is a flowchart of an example process 500 for dynamically generating an action by an automated agent, according to some embodiments.

At step 502, the system 100 may receive, via a communication interface, input data associated with a task type. The system may have a neural network 110 stored on a memory device of system 100 having a plurality of layers or blocks 304.

At step 504, the system 100 may select, from the plurality of layers of the neural network 110, a subset of layers based on at least the task type. The task type may correspond to a task policy 302 stored on a memory device of system 100.

In some embodiments, the selection of the subset of layers based on at least the task type is determined based on a task-specific policy 302.

At step 506, the system 100 may dynamically activate, based on the input data, at least one layer of the subset of layers.

In some embodiments, each of the subset of layers of the neural network is connected with a respective gating unit configured for dynamically activating or deactivating the respective layer of the subset of layers of the neural network.

In some embodiments, the respective gating unit dynamically activates the respective layer of the subset of layers by: computing, by an relevance estimator, a relevance metric of an intermediate feature input to the respective layer connected to the respective gating unit; and dynamically activating the respective layer connected to the respective gating unit based on the relevance metric.

In some embodiments, the respective gating unit dynamically activates the respective layer of the subset of layers when the relevance metric is at or above a predetermined threshold.

In some embodiments, the respective gating unit dynamically deactivates the respective layer of the subset of layers when the relevance metric is below a predetermined threshold.

In some embodiments, the relevance estimator includes two convolution layers and an activation function.

In some embodiments, the relevance estimator includes an average pooling function between the convolution layers and the activation function.

In some embodiments, the dynamically activating the at least one layer of the subset of layers comprises: determining an output using a Rectified Linear Unit (ReLU).

In some embodiments, steps 504 and 506 may be performed concurrently, as shown in FIG. 4, for example, given a block input X, the task-specific policy output u ∈ {0,1} can be refined or modified by the instance gating output w ∈ {0,1} to produce block output Y as follows:

$$Y = \{ \begin{matrix}residual ( X ) if u = 0 \\ residual ( X ) if u = 1 and w = 0 \\ ReLU ( residual ( X ) + Z ) if u = 1 and w = 1\end{matrix}$$

where Z is the output of the convolutional block.

When the task-specific policy output u and instance-specific gating output w both indicate that the block 304 should be activated (e.g., u=1 and w=1), the resulting block output is ReLU(residual(X)+Z), based on a Residual component 410 and a ReLU component 430. When either the task-specific policy or instance-specific gating does not activate the block (u=0 or w=0), the resulting output is residual(X), skipping that block 304.

A layer or block 304 is selected when the values of the task-specific policy output u and instance-specific gating output w both indicate that the layer or block 304 is relevant to the task and the input to that layer or block 304. In some embodiments, the specific input to block 304, X, may be intermediate feature representation generated by a previous block that was activated in the forward pass.

At step 508, the system 100 may generate an action signal based on a forward pass of the neural network 110 using the dynamically activated at least one layer of the neural network 110.

In some embodiments, training of the neural network 110 may include: optimizing a loss function that includes a first term for reducing a probability of an execution of a given layer and a second term that increases knowledge sharing between a plurality of tasks.

In accordance with a further aspect, the method may include outputting the relevance metric to facilitate decision-making transparency. For example, inputs which are simple to process may not be relevant to many layers and may have lower relevance metrics, while complex inputs may require analysis by many layers and therefore have higher relevance metrics.

In accordance with a further aspect, the action may include a response to a user query. In an embodiment, the method is configured to provide an automated agent that responds to user queries. The example method may parse the query to determine the substance of the user query using natural language processing, determine the substantive information to respond to the query, and formulate the response to naturally reply to the user's query. Once the example method has completed this, it can post its response to the user's query. In some embodiments, the users may be banking customers.

In accordance with a further aspect, the action may include a date or amount of a future payment or expense. In an embodiment, the method is configured to predict and post future expenses or credits for a user. In this example method, the prediction model for different types of expenses or credits may share some parameters, but not all. Further, the dynamic layer activation for similar types of expenses or credits may permit the method to potentially process the inputs more efficiently. In some embodiments, the users may be banking customers.

In accordance with a further aspect, the method may include training the neural network.

In accordance with a further aspect, the training may include optimizing a loss function that includes a first term for reducing the probability of the execution of a given layer and a second term that increases knowledge sharing between tasks.

In accordance with a further aspect, the training may include receiving a supervised training data set.

### Experiments

Experimental results and ablation studies are presented below based on an example implementation of the systems and methods described herein. An example embodiment is compared to single-task learning, as well as to traditional multi-task learning network. It can be shown that task and instance conditioning contribute to improved generalization performance in multi-task learning.

### Datasets and Evaluation Metrics

Performance of an example embodiment on three multi-task learning datasets is evaluated: NYU v2, CityScapes and MIMIC-III. Datasets from two distinct problem domains are included to demonstrate the versatility of task and instance conditioned parameter sharing approach in the example embodiment.

NYU v2 is a commonly adopted benchmark for evaluating multi-task learning methods. Two tasks, namely, predicting semantic segmentation and surface normals, are used in the experiments. Semantic segmentation is evaluated using mean Intersection over Union (mIoU) and Pixel Accuracy (Pixel acc). For surface normal prediction mean and median pixel error are recorded, which means the mean and median angle distance between the prediction and ground truth for all pixels. Additionally to mean and median pixel error, the percentage of predicted pixels are computed within the angles of 11.25°, 22.5° and 30°.

CityScapes is another dataset for benchmarking semantic segmentation and depth prediction. Semantic segmentation is evaluated using the same mean IoU and Pixel Accuracy from NYU v2. For depth prediction five metrics are used, absolute and relative errors and measures of the relative difference between prediction and ground truth by the percentage of

$$δ = max \{ \frac{{y}_{pred}}{{y}_{gt}} , \frac{{y}_{gt}}{{y}_{pred}} \}$$

within thresholds of 1.25, 1.25², 1.25³.

MIMIC-III consist of patients information from over 40,000 intensive care units (ICU) stays. The four tasks of this dataset are Phenotype prediction (Pheno), In-hospital mortality prediction (IHM), Length-of-stay (LOS), and Decompensation prediction (Decomp). MIMIC-III is the main benchmark for heterogenous multi-task learning with time series. It is considered heterogenous due to the different task characteristics. The dataset includes two binary tasks, one temporal multi-label task, and one temporal classification respectively.

The dataset includes two binary tasks, one temporal multi-label task, and one temporal classification task, respectively. For a fair comparison we adopted the same split between train, validation, and test set as used by all the previous baselines; the ratios are 70%, 15%, and 15%. The metric for comparing the results is AUC (Area Under The Curve) ROC for the binary tasks and Kappa Score for the multiclass tasks.

The multi-task learning performance of various MTL systems including an example embodiment, is reported with Δ as defined below which compares results with their equivalent single task values.

$${Δ}_{{𝒯}_{k}} = \frac{1}{\vert M \vert} {\sum }_{j = 0}^{\vert M \vert} {( - 1 )}^{{l}_{j}} ( {M}_{{𝒯}_{k} , j} - {M}_{S T , j} ) / {M}_{ST , j} * 100 \% , \qquad ( 7 )$$

where lⱼ=1 if a lower value shows better performance for the metric Mⱼ and 0 otherwise. M_{ST,j} is the single task value of j metric. k (lowercase) refers to the kₜₕ task, and K (uppercase) is the total number of tasks.

The overall performance is calculated by averaging [symbol] over all tasks.

$$Δ = \frac{1}{K} {\sum }_{k \leq K} {Δ}_{{𝒯}_{k}} , \qquad ( 8 )$$

where k (lowercase) refers to the kₜₕ task, and K (uppercase) is the total number of tasks.

### Training of Neural Network in MTL

In some embodiments, for an example training dataset such as NYU v2 dataset, Deeplab-ResNet-18 backbone is implemented as backbone as the neural network 110. Adam Optimizer may be used for task-specific policy learning and Stochastic gradient descent (SGD) optimization may be implemented for instance-specific gating during the re-training phase. During the re-training phase of the neural network 110 for instance-specific gating training, various (e.g., eight) different network architectures from the learned policy are sampled and the best re-train performance are reported below. The neural network 110 in the experimental setting is trained for 20000 epochs with learning rate to 0.001 that is halved every 10000 epochs, cross-entropy is used for semantic segmentation and inverse of cosine similarity is used for surface normal prediction. The neural network models are trained using the training set with batch 16 for training and re-training phases. During training each neural network is warmed up (no task policy learning) for 10000 epochs, which is followed by task-policy learning, with Gumbel-Softmax temperature of 5 decaying at a rate of 0.965 when baseline performance is met or exceeded, for another 10000 epochs. Next, re-training of each neural network learns instance-specific gating, with a constant Gumbel-Softmax temperature of 1, for 2000 epochs.

In some embodiments, for an example training dataset such as Cityscapes dataset, ResNet-34 (16) may be implemented as a backbone of the neural networks.

In some embodiments, for an example training dataset such as MIMIC-III dataset, ResNet-18 (9 blocks) may be implemented as a backbone of the neural networks. Adam may be used as optimizer for policy distribution parameters and SGD optimization may be used to update network weights. A learning rate of 0.001 that is halved every 250 epochs is set, binary cross-entropy loss for binary tasks and cross-entropy loss for multi-label tasks. The neural network models are trained using the training set for 1000 epochs, and the task's AUC sum was used in the validation set to define the best model, where the largest sum indicates the best epoch, and consequently, the best model. The models are trained using the training set with batch size of 256 for 1000 epochs.

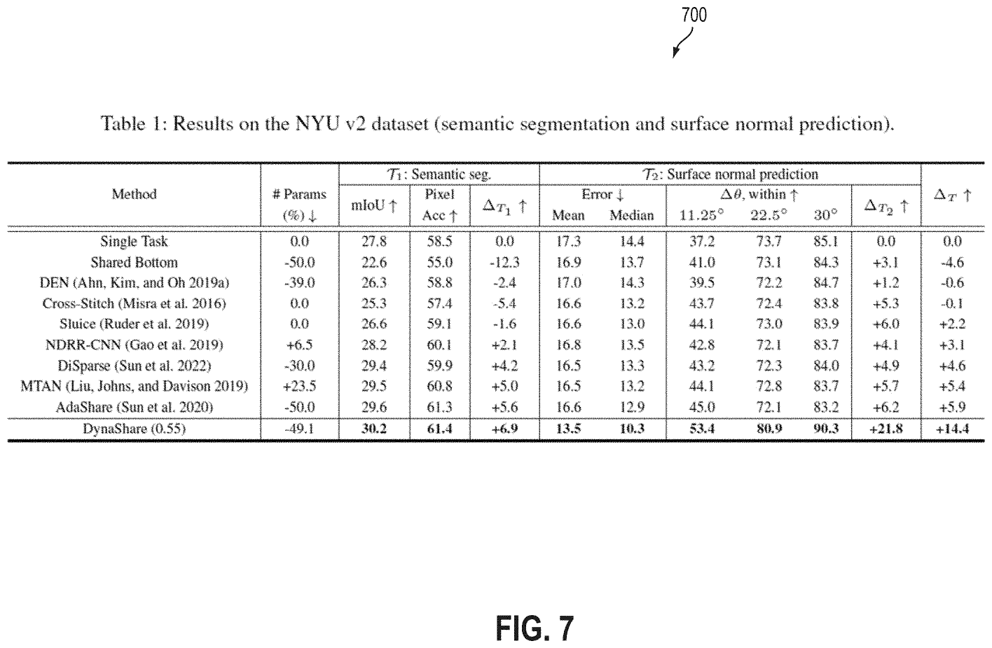

FIG. 7 shows a Table 1 including experimental results 700 on the NYU v2 dataset for the tasks of semantic segmentation and surface normal prediction. Throughout the disclosure, one or more example systems 100 implementing an embodiment of a multi-task learning neural network 100 may be denoted “DynaShare” or DynaShare (t), where t is the target rate (see Eq. 5). The target rate is applied for the layers in the last four ResNet blocks, while the first four ResNet blocks are always enabled. An example embodiment of systems 100 (DynaShare) can be seen to outperforms all baselines on 7 out of 7 metrics with an overall performance lift of Δ_{T}=+14.4, which is a relative improvement of 2.4× when compared to the traditional multi-task learning systems. On the surface normal prediction task, the example embodiment of systems 100 (DynaShare) more than triples the performance lift of the previous best performing approach (3.5× better).

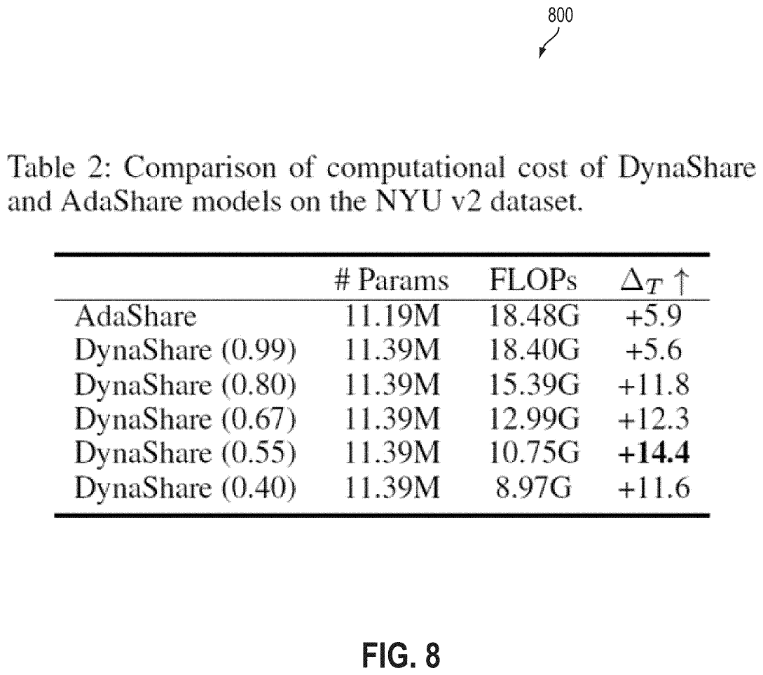

Table 2 in FIG. 8 shows a comparison of the computational cost 800 of the AdaShare (prior art) and systems 100 (DynaShare) models, based on NYU v2 dataset, for multiple instance gating target rates. The table shows that instance gating adds a small number of parameters (+1.8% relative) while reducing the FLOPs by 41.8% for the best performing target rate (0.55). The example embodiment of systems 100 (DynaShare (0.4)) model requires half the FLOPs of AdaShare while achieving almost twice the Δ_{T} improvement.

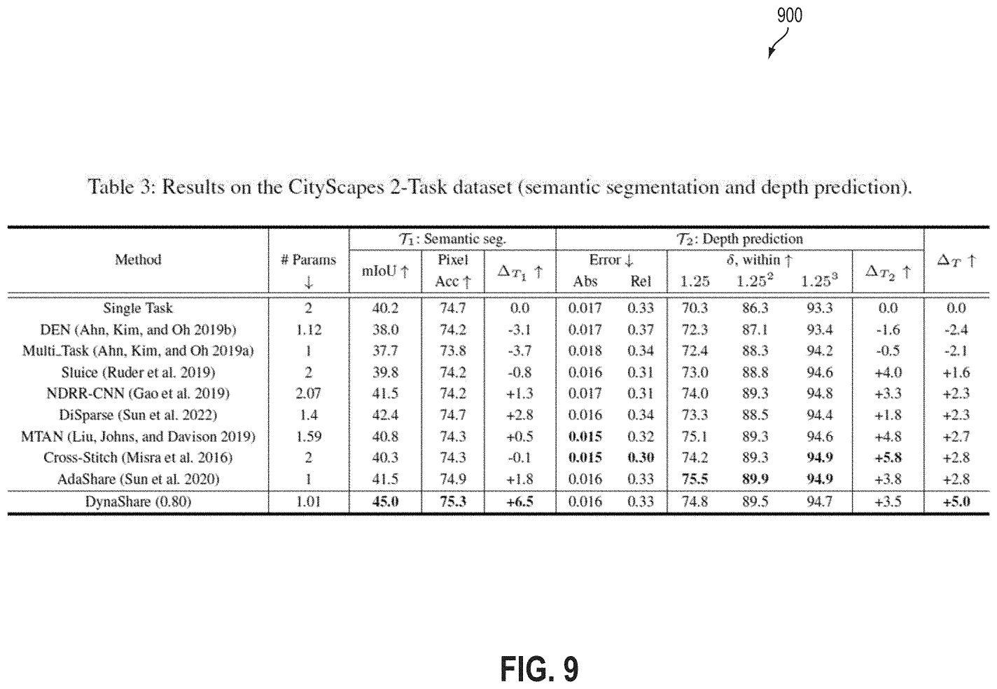

Table 3 in FIG. 9 shows experimental results 900 on the Cityscapes 2-Task dataset for the tasks of semantic segmentation and depth prediction. The target rate is applied for the layers in the last nine blocks, while the first seven blocks are always enabled. The example embodiment of systems 100 (DynaShare (0.80)) outperforms all baselines with an overall performance lift of Δ_{T}=+5.0, which is a relative improvement of 78% compared to the previous state-of-the-art. On semantic segmentation, DynaShare (0.80) more than doubles the performance lift of the previous best performing approach (2.3× better). On depth estimation the performance of DynaShare (0.80) is on par with the previous state-of-the-art. DynaShare (0.80) also presents the best performance balance among all compared methods. On one hand, Cross-Stitch is the best depth estimation method but presents a poor performance on semantic segmentation. On the other hand, DynaShare (0.80) is the best semantic segmentation technique and also performs on par with the top depth estimation methods. Therefore, the example embodiment of systems 100 (DynaShare (0.80)) is the sole method to present high performance on both tasks.

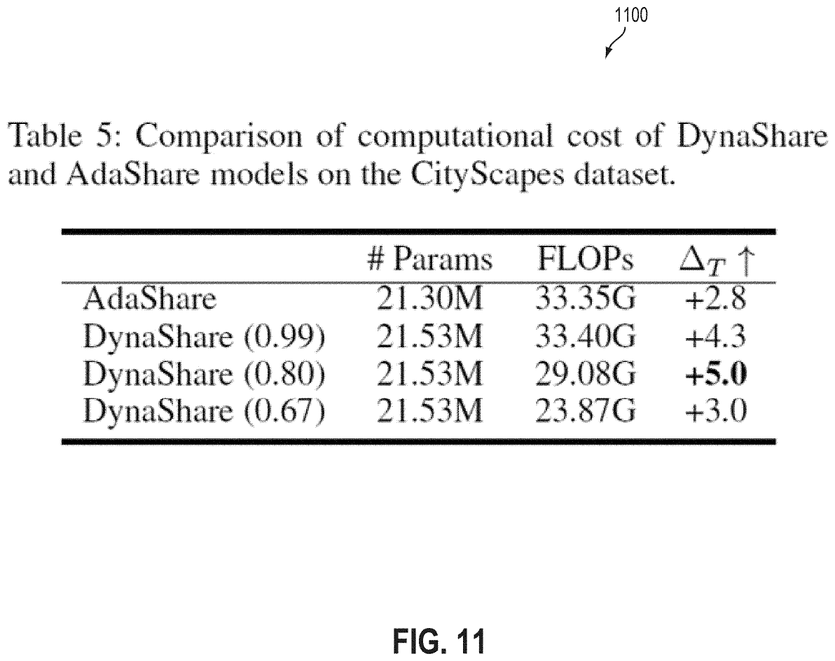

Table 5 in FIG. 11 shows a comparison of the computational cost 1100 of the AdaShare (prior art) and various embodiments of systems 100 (DynaShare) models for the CityScapes dataset. The table shows that instance gating in DynaShare models adds a small number of parameters (+1.1% relative) while reducing the FLOPs by 13% for the best performing target rate (0.80). For this dataset, a lower instance gating rate (sparser gating) has a stronger negative impact on performance, and 80% target coverage is the best setting. However, the FLOPs on the DynaShare models can be reduced further, to almost 30% less than AdaShare, while still achieving better Δ_{T}.

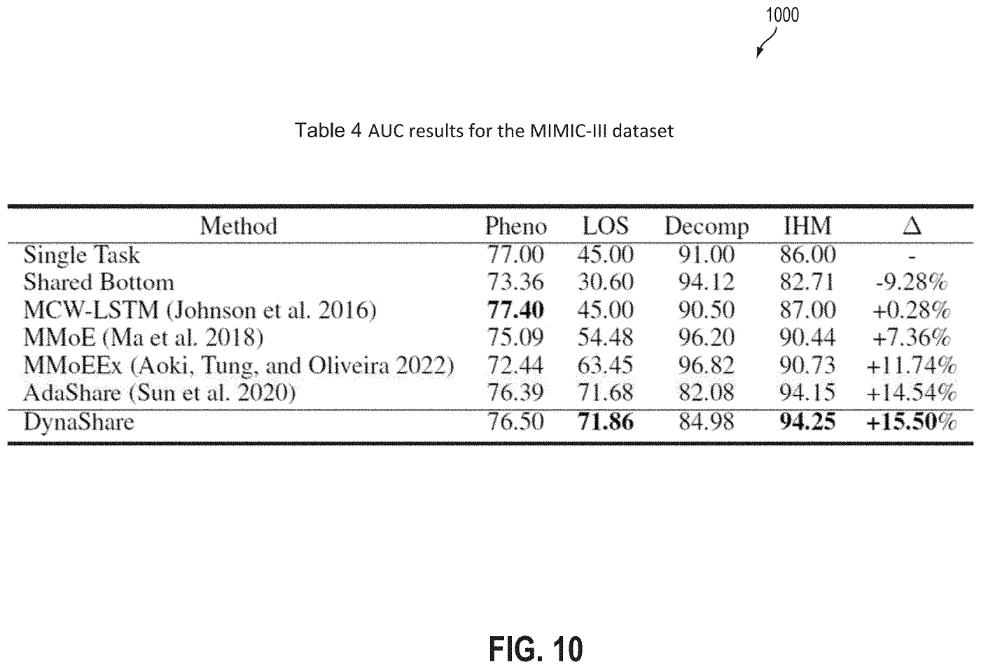

Table 4 in FIG. 10 shows AUC results 1000 for the MIMIC-III dataset. The example embodiment of systems 100 (DynaShare) outperforms all other baselines in two out of four individual tasks, and achieves an overall lift in relative performance when considering the full set of tasks.

More specifically, for this time series based dataset (MIMIC-III dataset), DynaShare is compared with single-task training (separate networks trained for each task), hard-parameter sharing, channel wise LSTM (MCW-LSTM) ([11]), MMoE ([19]), MMoEEx ([2]), and AdaShare. AdaShare and DynaShare are the strongest performers on the dataset, demonstrating the versatility of task and instance conditioned weight sharing in the time series domain. DynaShare performs modestly better than AdaShare on all four tasks. Overall, DynaShare achieves the highest performance in two out of the four tasks, and the highest average delta improvement relative to the single-task model (+15.50%).

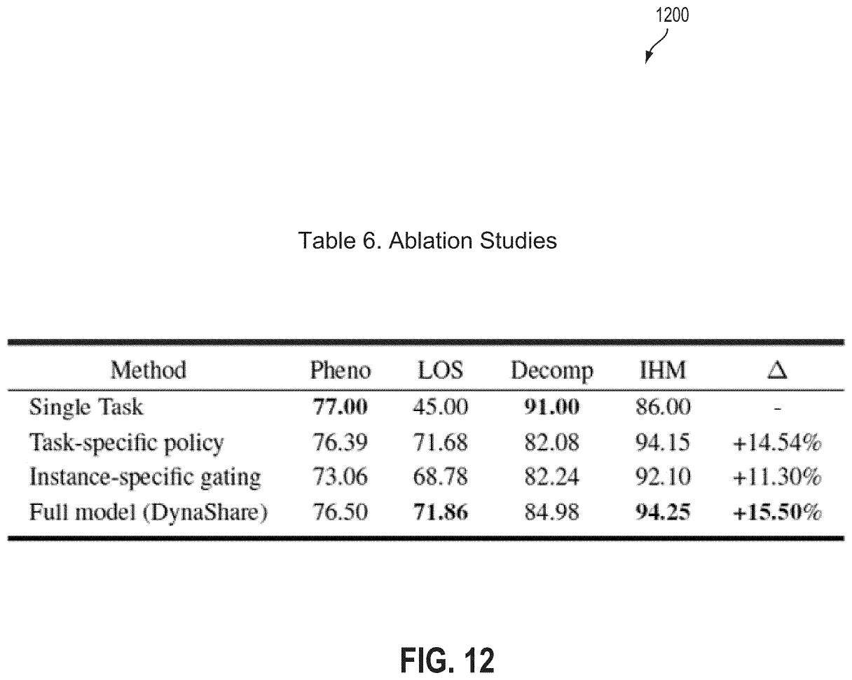

To evaluate the impact of both the task-specific policy and instance-specific gating components, ablation experiments are conducted on the MIMIC-III dataset. First, the neural network 110 is trained with a task-specific policy only. With a task-specific policy only, a +2.8% lift in performance is achieved compared to the best previous baseline (MMoEEx). Next, the neural network 110 is trained (re-trained) with instance-specific gating only. This achieves similar performance with state of the art technique. The full results of these ablation studies are reported in Table 6 as shown in FIG. 12. Table 6 shows ablation studies 1200 to evaluate the impact of the task-specific policy and instance-specific gating on overall multi-task learning performance on the MIMIC-III dataset.

In summary, both the task-specific policy and instance-specific gating improve the performance of the neural network 110 in example embodiments, as implemented by system 100. For ResNet-18 the instance gating function only adds 0.4% to the task-specific network parameters at training, while it improves the average relative performance of all tasks by 0.96%.

System 100 provides a flexible task and instance conditioned parameter sharing architecture for boosting the generalization performance of multi-task networks such as neural network 110. System 100 conditions layer-wise parameter sharing as a function of both the task and the intermediate feature representations by learning a hierarchical gating policy.

The conditioning on intermediate feature representations to achieve more flexible parameter sharing as provided by system 100 may be further applicable to other learning problems in which parameter sharing plays an important role, such as neural architecture search, continual (lifelong) learning, and multimodal learning.

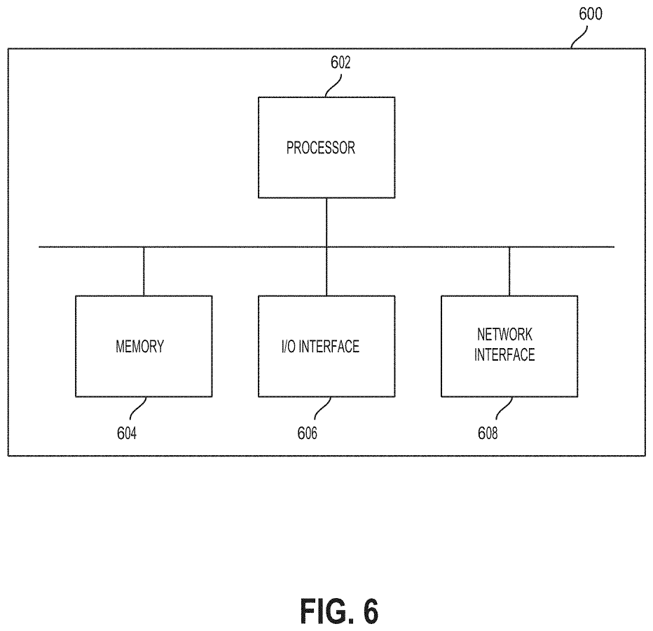

FIG. 6 is a schematic diagram of an example computing device 600 suitable for implementing system 100, in accordance with an embodiment. As depicted, computing device 600 includes one or more processors 602, memory 604, one or more I/O interfaces 606, and, optionally, one or more network interfaces 608.

Each processor 602 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 604 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 604 may store code executable at processor 602, which causes system 100 to function in manners disclosed herein. Memory 604 includes a data storage. In some embodiments, the data storage includes a secure database. In some embodiments, the data storage stores received data sets, such as textual data, image data, or other types of data.

Each I/O interface 606 enables computing device 600 to interconnect with one or more input devices, such as a keyboard, mouse, camera, touch screen and a microphone, or with one or more output devices such as a display screen and a speaker.

Each network interface 608 enables computing device 600 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The methods disclosed herein may be implemented using a system 100 that includes multiple computing devices 600. The computing devices 600 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 600 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references were made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

### REFERENCES

[1] Çagla Aksoy and Alper Ahmetoglu and Tunga Güngör. Hierarchical Multitask Learning Approach for BERT. arXiv preprint arXiv:2011.04451, 2020.
[2] Aoki, Raquel and Tung, Frederick and Oliveira, Gabriel L. Heterogeneous Multi-task Learning with Expert Diversity. arXiv preprint arXiv:2106.10595, 2021.
[3] Bengio, Yoshua and Louradour, Jerome and Collobert, Ronan and Weston, Jason. Curriculum learning. International Conference on Machine Learning, 2009.
[4] Caruana, Rich. Multitask Learning: A Knowledge-Based Source of Inductive Bias. International Conference on Machine Learning, 1993.
[5] Chen, Zhourong and Li, Yang and Bengio, Samy and Si, Si. You Look Twice: GaterNet for Dynamic Filter Selection in CNNs. IEEE/CVF Conference on Computer Vision and Pattern Recognition, 2019.
[6] Zichao Guo and Xiangyu Zhang and Haoyuan Mu and Wen Heng and Zechun Liu and Yichen Wei and Jian Sun. Single Path One-Shot Neural Architecture Search with Uniform Sampling. European Conference on Computer Vision, 2020.
[7] Yizeng Han and Gao Huang and Shiji Song and Le Yang and Honghui Wang and Yulin Wang. Dynamic Neural Networks: A Survey. arXiv preprint arXiv:2102.04906, 2021.
[8] Harutyunyan, Hrayr and Khachatrian, Hrant and Kale, David C and Ver Steeg, Greg and Galstyan, Aram. Multitask learning and benchmarking with clinical time series data. Scientific data, 6(1):1-18, 2019.
[9] Matteo Hessel and Hubert Soyer and Lasse Espeholt and Wojciech Czarnecki and Simon Schmitt and Hado van Hassett. Multi-task Deep Reinforcement Learning with PopArt. Technical report, DeepMind, 2019.
[10] Jang, Eric and Gu, Shixiang and Poole, Ben. Categorical reparameterization with gumbel-softmax. arXiv preprint arXiv:1611.01144, 2016.
[11] Johnson, Alistair E W and Pollard, Tom J and Shen, Lu and Li-Wei, H Lehman and Feng, Mengling and Ghassemi, Mohammad and Moody, Benjamin and Szolovits, Peter and Celi, Leo Anthony and Mark, Roger G. MIMIC-III, a freely accessible critical care database. Scientific data, 3(1):1-9, 2016.
[12] Kim, Eunwoo and Ahn, Chanho and Oh, Songhwai. NestedNet: Learning Nested Sparse Structures in Deep Neural Networks. IEEE Conference on Computer Vision and Pattern Recognition, 2018.
[13] Kokkinos, lasonas. UberNet: Training a ‘Universal’ Convolutional Neural Network for Low-, Mid-, and High-Level Vision using Diverse Datasets and Limited Memory. IEEE Conference on Computer Vision and Pattern Recognition, 2017.
[14] Changlin Li and Guangrun Wang and Bing Wang and Xiaodan Liang and Zhihui Li and Xiaojun Chang. Dynamic Slimmable Network. IEEE/CVF Conference on Computer Vision and Pattern Recognition, 2021.
[15] Hanxiao Liu and Karen Simonyan and Yiming Yang. DARTS: Differentiable Architecture Search. International Conference on Learning Representations, 2019.
[16] Liu, Shikun and Johns, Edward and Davison, Andrew J. End-to-end multi-task learning with attention. IEEE Conference on Computer Vision and Pattern Recognition, 2019.
[17] Liu, Xiaodong and He, Pengcheng and Chen, Weizhu and Gao, Jianfeng. Multi-Task Deep Neural Networks for Natural Language Understanding. Annual Meeting of the Association for Computational Linguistics, 2019.
[18] Lu, Jiasen and Goswami, Vedanuj and Rohrbach, Marcus and Parikh, Devi and Lee, Stefan. 12-in-1: Multi-Task Vision and Language Representation Learning. The IEEE/CVF Conference on Computer Vision and Pattern Recognition, 2020.
[19] Ma, Jiaqi and Zhao, Zhe and Yi, Xinyang and Chen, Jilin and Hong, Lichan and Chi, Ed H. Modeling task relationships in multi-task learning with multi-gate mixture-of-experts. ACM SIGKDD International Conference on Knowledge Discovery & Data Mining, 2018.
[20] Maninis, Kevis-Kokitsi and Radosavovic, Ilija and Kokkinos, lasonas. Attentive single-tasking of multiple tasks. IEEE/CVF Conference on Computer Vision and Pattern Recognition, 2019.
[21] Misra, Ishan and Shrivastava, Abhinav and Gupta, Abhinav and Hebert, Martial. Cross-stitch networks for multi-task learning. IEEE Conference on Computer Vision and Pattern Recognition, 2016.
[22] Lerrel Pinto and Abhinav Gupta. Learning to Push by Grasping: Using multiple tasks for effective learning. arXiv preprint arXiv:1609.09025, 2016.
[23] Pramanik, Subhojeet and Agrawal, Priyanka and Hussain, Aman. OmniNet: A unified architecture for multi-modal multi-task learning. arXiv preprint arXiv:1907.07804, 2019.
[24] Sanh, Victor and Wolf, Thomas and Ruder, Sebastian. A Hierarchical Multi-Task Approach for Learning Embeddings from Semantic Tasks. AAAI Conference on Artificial Intelligence, 2019.
[25] Ximeng Sun and Rameswar Panda and Rogerio Feris and Kate Saenko. AdaShare: Learning What To Share For Efficient Deep Multi-Task Learning. Advances in Neural Information Processing Systems, 2020.
[26] Vandenhende, Simon and Georgoulis, Stamatios and Van Gool, Luc. MTI-Net: Multi-Scale Task Interaction Networks for Multi-Task Learning. European Conference on Computer Vision, 2020.
[27] Andreas Veit and Serge Belongie. Convolutional networks with adaptive computation graphs. European Conference on Computer Vision, 2018.
[28] Thomas Verelst and Tinne Tuytelaars. Dynamic Convolutions: Exploiting Spatial Sparsity for Faster Inference. IEEE/CVF Conference on Computer Vision and Pattern Recognition, 2020.
[29] Ruochen Wang and Minhao Cheng and Xiangning Chen and Xiaocheng Tang and Cho-Jui Hsieh. Rethinking Architecture Selection in Differentiable NAS. International Conference on Learning Representations, 2021.
[30] Xin Wang and Fisher Yu and Zi-Yi Dou and Trevor Darrell1 and Joseph E. Gonzalez. SkipNet: Learning Dynamic Execution in Residual Networks. European Conference on Computer Vision, 2018.
[31] Yikai Wang and Fuchun Sun and Duo Li and Anbang Yao. Resolution Switchable Networks for Runtime Efficient Image Recognition. European Conference on Computer Vision, 2020.
[32] Wang, Yue and Shen, Jianghao and Hu, Ting-Kuei and Xu, Pengfei and Nguyen, Tan and Baraniuk, Richard and Wang, Zhangyang and Lin, Yingyan. Dual Dynamic Inference: Enabling More Efficient, Adaptive and Controllable Deep Inference. IEEE Journal of Selected Topics in Signal Processing, 2020.
[33] Zuxuan Wu and Tushar Nagarajan and Abhishek Kumar and Steven Rennie and Larry S. Davis and Kristen Grauman and Rogerio Feris. BlockDrop: Dynamic inference paths in residual networks. IEEE Conference on Computer Vision and Pattern Recognition, 2018.
[34] Jiahui Yu and Thomas Huang. Universally Slimmable Networks and Improved Training Techniques. IEEE/CVF International Conference on Computer Vision, 2019.
[35] Jiahui Yu and Linjie Yang and Ning Xu and Jianchao Yang and Thomas Huang. Slimmable Neural Networks. International Conference on Learning Representations, 2019.

1. A computer-implemented system for computing an action for an automated agent, the system comprising:
a communication interface;
at least one processor;
memory in communication with the at least one processor, the memory storing a neural network for deep multi-task learning; and
software code stored in the memory, which when executed at the at least one processor causes the system to:
receive, via the communication interface, input data associated with a task type;
select, from a plurality of layers of the neural network, a subset of layers based on at least the task type;
dynamically activate, based on the input data, at least one layer of the subset of layers; and
generate an action signal based on a forward pass of the neural network using the dynamically activated at least one layer of the neural network.

2. The system of claim 1, wherein each of the subset of layers of the neural network is connected with a respective gating unit configured for dynamically activating or deactivating the respective layer of the subset of layers of the neural network.

3. The system of claim 2, wherein the respective gating unit dynamically activates the respective layer of the subset of layers by:
computing, by an relevance estimator, a relevance metric of an intermediate feature input to the respective layer connected to the respective gating unit; and
dynamically activating the respective layer connected to the respective gating unit based on the relevance metric.

4. The system of claim 3, wherein the respective gating unit dynamically activates the respective layer of the subset of layers when the relevance metric is at or above a predetermined threshold.

5. The system of claim 3, wherein the respective gating unit dynamically deactivates the respective layer of the subset of layers when the relevance metric is below a predetermined threshold.

6. The system of claim 3, wherein the relevance estimator comprises two convolution layers and an activation function.

7. The system of claim 4, wherein the relevance estimator comprises an average pooling function between the convolution layers and the activation function.

8. The system of claim 1, wherein the selection of the subset of layers based on at least the task type is determined based on a task-specific policy.

9. The system of claim 1, wherein the dynamically activating the at least one layer of the subset of layers comprises: determining an output using a Rectified Linear Unit (ReLU).

10. The system of claim 1, wherein training of the neural network comprises: optimizing a loss function that includes a first term for reducing a probability of an execution of a given layer and a second term that increases knowledge sharing between a plurality of tasks.

11. A computer-implemented method for dynamically generating an action by an automated agent, the method comprising:
receiving, via a communication interface, input data associated with a task type;
selecting, from a plurality of layers of a neural network, a subset of layers based on at least the task type;
dynamically activating, based on the input data, at least one layer of the subset of layers; and
generating an action signal based on a forward pass of the neural network using the dynamically activated at least one layer of the neural network.

12. The computer-implemented method of claim 11, wherein each of the subset of layers of the neural network is connected with a respective gating unit configured for dynamically activating or deactivating the respective layer of the subset of layers of the neural network.

13. The computer-implemented method of claim 12, wherein the respective gating unit dynamically activates the respective layer of the subset of layers by:
computing, by an relevance estimator, a relevance metric of an intermediate feature input to the respective layer connected to the respective gating unit; and
dynamically activating the respective layer connected to the respective gating unit based on the relevance metric.

14. The computer-implemented method of claim 13, wherein the respective gating unit dynamically activates the respective layer of the subset of layers when the relevance metric is at or above a predetermined threshold.

15. The computer-implemented method of claim 13, wherein the respective gating unit dynamically deactivates the respective layer of the subset of layers when the relevance metric is below a predetermined threshold.

16. The computer-implemented method of claim 13, wherein the relevance estimator comprises two convolution layers and an activation function.

17. The computer-implemented method of claim 11, wherein the selection of the subset of layers based on at least the task type is determined based on a task-specific policy stored in the memory.

18. The computer-implemented method of claim 11, wherein the dynamically activating the at least one layer of the subset of layers comprises: determining an output using a Rectified Linear Unit (ReLU).

19. The computer-implemented method of claim 11, wherein training of the neural network comprises: optimizing a loss function that includes a first term for reducing a probability of an execution of a given layer and a second term that increases knowledge sharing between a plurality of tasks.

20. A non-transitory computer-readable storage medium storing instructions which when executed adapt at least one computing device to:
receive, via a communication interface, input data associated with a task type;
select, from a plurality of layers of a neural network, a subset of layers based on at least the task type;
dynamically activate, based on the input data, at least one layer of the subset of layers; and
generate an action signal based on a forward pass of the neural network using the dynamically activated at least one layer of the neural network.
